(19) United States
(12) Patent Application Publication
(10) Pub. No.: US 2014/0060144 A1
(43) Pub. Date: Mar. 6, 2014

(54) METHOD AND APPARATUS FOR CALIBRATING DISPENSED DEPOSITS

(71) Applicants: Jonathan J. Bloom, North Falmouth, MA (US); Satish Kaveti, Sharon, MA (US)

(72) Inventors: Jonathan J. Bloom, North Falmouth, MA (US); Satish Kaveti, Sharon, MA (US)

(73) Assignee: Illnois Tool Works Inc., Glenview, IL (US)

(21) Appl. No.: 13/598,719

(22) Filed: Aug. 30, 2012

(51) Int. Cl. G01D 18/00

(52) U.S. Cl. 73/1.01

(57) ABSTRACT

A method of calibrating a dispenser, which has a material dispensing unit that is configured to dispense material on a substrate, includes dispensing a line of material on a surface, capturing at least one image of the line dispensed on the surface, calculating an average line width of the line dispensed on the surface, and comparing the average line width of the line dispensed on the surface to a desired line width. A controller configured to perform the method is further disclosed.

### BACKGROUND OF THE INVENTION

1. Field of the Disclosure

This disclosure relates generally to methods and apparatus for dispensing a viscous material on a substrate, such as a printed circuit board, and more particularly to a method and an apparatus for calibrating or otherwise verifying an amount dispensed on a substrate with enhanced efficiency.

2. Discussion of Related Art

There are several types of prior art dispensing systems used for dispensing precise amounts of liquid or paste for a variety of applications. One such application is the assembly of integrated circuit chips and other electronic components onto circuit board substrates. In this application, automated dispensing systems are used for dispensing very small amounts, or dots, of viscous material onto a circuit board. The viscous material may include liquid epoxy or solder paste, or some other related material.

There are known methods for calibrating a dispensing system to accurately control the rate and amount of viscous material that is dispensed from a dispensing unit of the dispensing system. One issue is that solder paste is difficult to dispense for weighing purposes since the amount of solder paste deposited cannot be accurately controlled. For example, a quantity of material may be dispensed and weighed to determine if the unit is dispensing the desired amount of material for a given configuration of the system. One approach is to adjust the speed of the gantry carrying the dispensing head based on the weighed sample or samples to vary the amount deposited by the dispensing system. Another approach is to adjust the shot size dispensed by the dispensing head. One such system is shown and described in U.S. patent application Ser. No. 13/072,355, filed on Mar. 25, 2011, and entitled METHOD AND APPARATUS FOR CALIBRATING DISPENSED DEPOSITS, which is incorporated herein by reference in its entirety for all purposes.

### BRIEF SUMMARY OF THE INVENTION

One aspect of the present disclosure is directed to a method of calibrating a dispenser of the type having a material dispensing unit that is configured to dispense material on a substrate. In one embodiment, the method comprises: dispensing a line of material on a surface; capturing at least one image of the line dispensed on the surface; calculating an average line width of the line dispensed on the surface; and comparing the average line width of the line dispensed on the surface to a desired line width.

Embodiments of the method further may include displaying the average line width and weight of the line dispensed to a user using a user interface device. The user interface device may include a display coupled to a dispenser controller. Comparing the average line width to the desired line width may include determining whether the average line width is within a predetermined tolerance. If the average line width is outside the predetermined tolerance, the method further may comprise repeating dispensing, capturing, calculating and comparing until the average line width is within the predetermined tolerance. The method further may comprise adjusting a parameter of the dispenser to vary an amount of material dispensed in the event the average line width is outside the predetermined tolerance. Adjusting the parameter of the dispenser may include adjusting a speed of the gantry. Adjusting the parameter of the dispenser may include adjusting a rotation of an auger screw of the dispensing unit or by adjusting the shot size of the dispensing unit. Capturing at least one image may include capturing a plurality of images at one or more places along a length of the line. In a certain embodiment, the predetermined tolerance is ten percent (10%).

Another aspect of the disclosure is directed to a controller coupled to a dispenser of the type having a material dispensing unit that is configured to dispense material on a substrate. In one embodiment, the controller comprises a calibration component configured to perform acts of dispensing a line of material on a surface, capturing at least one image of the line dispensed on the surface, calculating an average line width of the line dispensed on the surface, and comparing the average line width of the line dispensed on the surface to a desired line width.

Embodiments of the controller further may comprise displaying the average line width and weight of the line dispensed to a user using a user interface device. The user interface device may include a display coupled to a dispenser controller. Comparing the average line width to the desired line width may include determining whether the average line width is within a predetermined tolerance. If the average line width is outside the predetermined tolerance, the controller further may comprise repeating dispensing, capturing, calculating and comparing until the average line width is within the predetermined tolerance. The controller further may comprise adjusting a parameter of the dispenser to vary an amount of material dispensed in the event the average line width is outside the predetermined tolerance. Adjusting the parameter of the dispenser may include adjusting a speed of the gantry. Adjusting the parameter of the dispenser may include adjusting a rotation of an auger screw of the dispensing unit or adjusting the shot size of the dispensing unit. Capturing at least one image may include capturing a plurality of images at one or more places along a length of the line. In a certain embodiment, the predetermined tolerance is ten percent (10%).

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a side schematic view of a dispenser in accordance with one embodiment of the present disclosure;

FIG. 2 is a schematic block diagram of a method of determining an amount of material dispensed on a substrate;

FIG. 3 is a top plan schematic view of an exemplary line of material dispensed on a substrate;

FIG. 4 is a screen shot of an exemplary user interface;

FIG. 5 is a screen shot of a dialog box showing an interface for performing a method of the present disclosure; and

FIG. 6 is a screen shot of an exemplary line of material dispensed on a substrate.

### DETAILED DESCRIPTION OF THE INVENTION

For the purposes of illustration only, and not to limit the generality, the present disclosure will now be described in detail with reference to the accompanying figures. This disclosure is not limited in its application to the details of construction and the arrangement of components set forth in the following description or illustrated in the drawings. The principles set forth in this disclosure are capable of other embodiments and of being practiced or carried out in various ways. Also the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

Various embodiments of the present disclosure are directed to viscous material dispensing systems, devices including dispensing systems, and methods of determining the amount dispensed by such dispensing systems. Such dispensing systems are often used to dispense solder paste, which can be difficult to dispense for weighing the quantity dispensed. It has been found that by measuring a width of dispensed lines of solder paste can afford closed loop control of the amount or quantity dispensed. The line width measurement method described herein does not produce a volume oriented measurement, but instead “assumes” that the dispensed line will be consistent enough in height (or more exactly, in cross-section) so that an effective means of closed loop control can be achieved from measuring the width.

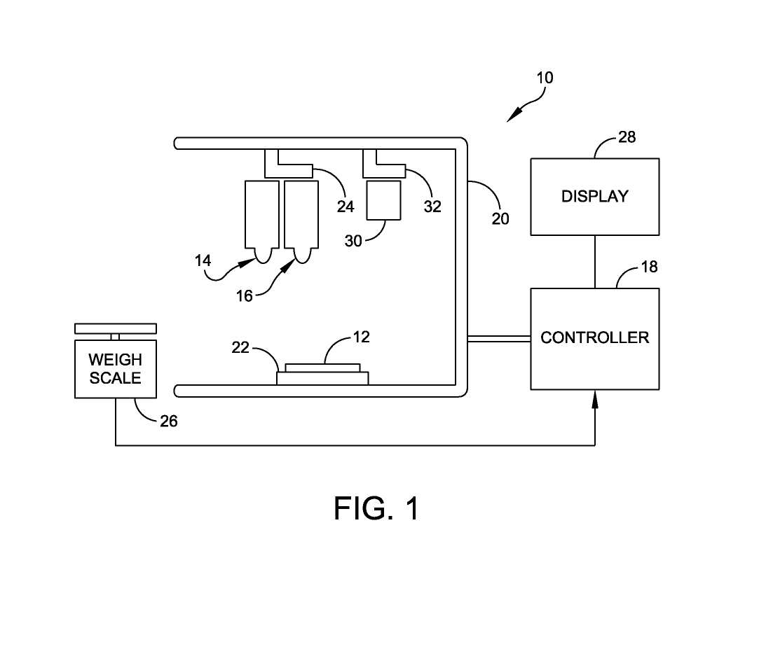

FIG. 1 schematically illustrates a dispenser, generally indicated at 10, according to one embodiment of the present disclosure. The dispenser 10 is used to dispense a viscous material (e.g., an adhesive, encapsulant, epoxy, solder paste, underfill material, etc.) or a semi-viscous material (e.g., soldering flux, etc.) onto an electronic substrate 12, such as a printed circuit board or semiconductor wafer. The dispenser 10 may alternatively be used in other applications, such as for applying automotive gasketing material or in certain medical applications. It should be understood that references to viscous or semi-viscous materials, as used herein, are exemplary and intended to be non-limiting. The dispenser 10 includes at least one dispensing unit or head, generally indicated at 14, an optional dispensing unit or head, generally indicated at 16, and a controller 18 to control the operation of the dispenser. Although two dispensing units are shown, it should be understood that any number of dispensing units may be provided. The dispenser 10 may also include a frame 20 having a base 22 for supporting the substrate 12, a dispensing unit gantry 24 movably coupled to the frame 20 for supporting and moving the dispensing unit 14, and a weight measurement device or weigh station 26 for weighing dispensed quantities of the viscous material, for example, as part of a calibration procedure, and providing weight data to the controller 18. A conveyor system (not shown) or other transfer mechanism such as a walking beam may be used in the dispenser 10 to control loading and unloading of circuit boards to and from the dispenser. The gantry 24 can be moved using motors under the control of the controller 18 to position the dispensing unit 14 and/or 16 at predetermined locations over the circuit board. The dispenser 10 may optionally include a display unit or display 28 connected to the controller 18 for displaying various information to a user. There may be an optional second controller for controlling the second dispensing unit 16.

Prior to performing a dispensing operation, as described above, the electronic substrate, e.g., printed circuit board, must be aligned or otherwise in registration with the dispensing unit of the dispenser. The dispenser further includes a vision system 30, which is coupled to a vision system gantry 32 movably coupled to the frame 20 for supporting and moving the vision system. As described, the vision system 30 is employed to verify the location of landmarks, known as fiducials, on the substrate. Once located, the controller can be programmed to manipulate the movement of the dispensing unit 14 and/or 16 to dispense material on the electronic substrate. The vision system 30 can also be used to inspect boards upon which assembly material is deposited to ensure that the material is deposited on the correct locations.

Each dispensing unit 14, 16 may be configured to dispense very small amounts or dots onto a circuit board. In one system capable of dispensing dots of material, the dispensing unit 14 and/or 16 utilizes a rotating auger having a helical groove to force material out of a nozzle and onto a circuit board. One such system is disclosed in U.S. Pat. No. 5,819,983, entitled LIQUID DISPENSING SYSTEM WITH SEALING AUGERING SCREW AND METHOD FOR DISPENSING, which is owned by Speedline Technologies, Inc. of Franklin, Mass., a subsidiary of the assignee of the present disclosure. In an operation employing an auger-type dispenser, the dispenser unit is lowered towards the surface of the circuit board prior to dispensing a dot or a line of material onto the circuit board and raised after dispensing the dot or line of material. Using this type of dispenser, small, precise quantities of material may be placed with great accuracy. The time required to lower and raise the dispenser unit in a direction normal to the circuit board, typically known as a z-axis movement, can contribute to the time required to perform dispensing operations. Specifically, with auger-type dispensers, prior to dispensing the dot or line of material, the dispenser unit is lowered so that the material touches or “wets” the circuit board. The process of wetting contributes to additional time to perform the dispensing operation.

It is also known in the field of automated dispensers to launch or jet dots of viscous material toward the circuit board. In such a jetter-type system, a minute, discrete quantity of viscous material is ejected from a nozzle with sufficient inertia to enable the material to separate from the nozzle prior to contacting the circuit board. As discussed above, with the auger-type application or other prior, traditional dispensers, it is necessary to wet the circuit board with the dot of material prior to releasing the dot from the nozzle. When ejecting, the dots may be deposited on the substrate without wetting as a pattern of discrete dots, or alternatively the dots may be placed sufficiently close to each other to cause them to coalesce into more or less a continuous pattern. One such jetter-type system is disclosed in U.S. Pat. No. 7,980,197, entitled METHOD AND APPARATUS FOR DISPENSING A VISCOUS MATERIAL ON A SUBSTRATE, which is owned by Illinois Tool Works Inc. of Glenview, Ill., the assignee of the present disclosure.

In one embodiment, the dispenser 10 is configured to dispense viscous material using a conventional “streaming” technique, wherein the dispenser launches discrete amounts, or shots, of the material toward the substrate at a controlled volumetric flow rate for each deposit. The dispenser 10 may be configured to dispense varying amounts of material in a controllable manner. It is appreciated that the amount of material dispensed in a given configuration of the dispenser 10 may vary with respect to the viscosity of the material being dispensed. For example, materials with a higher viscosity tend to be more resistive to flow than materials with lower viscosity, thus affecting the flow rate of the dispenser 10 in a given configuration and for a given material. Further, the viscosity of a particular material may vary over relatively short periods of time (e.g., hours) due to changes in the temperature or other properties of the material, or as a consequence of variations in composition (e.g., between different batches of the material), which further affects the flow rate and, accordingly, the quantity of material deposited per shot. Therefore, according to some aspects, the amount of material dispensed by the dispenser 10 in a given configuration can be determined as a function of the viscosity of the material at the time it is being dispensed. One exemplary function will be described below.

Since it can be important to carefully control the amount of material being dispensed, the dispenser 10 should be calibrated prior to, or during, use to ensure that the desired quantity of material will be dispensed in a predictable manner. According to one embodiment, information gathered during the calibration process may be used, on a periodic or continuous basis, to automatically adjust the dispenser 10 to maintain a desired volumetric flow in response to variations in the viscosity of the material.

One calibration process includes weighing samples of material dispensed by the dispensing head 14 and/or 16. For example, a series of samples may be dispensed and weighed. An output function can therefore be derived from this sample data that describes the expected output of the dispenser in a given configuration for a given material having a given viscosity. Using the derived output function, a calibrated dispense operation which produces a desired quantity (or weight) of dispensed material may be determined with reasonable accuracy at least for the dispensing head 14 and/or 16 from which the samples were taken.

In at least one embodiment, it is appreciated that where two or more dispensing heads, each being substantially identical in configuration, are used to dispense the same or similar material, the output characteristics of one dispensing head relative to another may be substantially similar such that the output functions of each head are nearly identical. In some of these embodiments, any differences between the output functions of the multiple dispensing heads can be accounted for by applying an offset variable to the derived output function of one of the dispensing heads. For example, if the output of a first dispensing head is described by y=f(x), the output of a second dispensing head can be described by y=f(x)+offset with reasonable accuracy, provided that both the first and second heads are dispensing the same material having substantially the same viscosity. The offset can be used to quickly apply calibration adjustments to the dispenser 10. For example, it is known that the viscosity of a material can change over the course of a few hours. Therefore it may be advantageous to recalibrate the dispenser 10 at periodic intervals of operation to help ensure that the actual output is within desired tolerances. To expedite the recalibration process, the sampling procedure described above is performed on only one of the dispensing heads to calculate the derived output function for that head. The corresponding (and previously calculated) offset values are then applied to the output function for each of the other dispensing heads.

One exemplary configuration procedure of the dispenser 10 will now be described according to various embodiments of the present disclosure. In one embodiment, the configuration procedure enables a user to configure the dispenser 10 to dispense a specific amount of material per shot, and further to enable the dispenser to measure and/or apply corrections, if necessary, such that the output of the dispenser remains substantially the same over a period of time (e.g., one day of operation) to account for any changes in the viscosity (or other property) of the material. In another embodiment, the configuration procedure enables the user to calibrate a dispenser 10 having two dispensing heads to ensure that the output of both heads is substantially the same.

According to various embodiments, it is appreciated that in situations where multiple dispensers are performing similar dispensing operations (e.g., in a shop having multiple dispensing machines running at the same time to produce the same parts), the above described characterization process is desirable for ensuring that a consistent volume of material is dispensed for all parts from all of the dispensing machines. In some embodiments, two or more dispensing machines may be networked together such that all such networked machines can be configured from a single point.

The computer system may include an operating system that manages at least a portion of the hardware elements included in the computer system. Usually, a processor or controller executes an operating system which may be, for example, a Windows-based operating system, such as, Windows NT, Windows 2000 (Windows ME), Windows XP or Windows Vista operating systems, available from the Microsoft Corporation, a MAC OS System X operating system available from Apple Computer, one of many Linux-based operating system distributions, for example, the Enterprise Linux operating system available from Red Hat Inc., a Solaris operating system available from Sun Microsystems, or a UNIX operating system available from various sources. Many other operating systems may be used, and the embodiments disclosed herein are not intended to be limited to any particular implementation.

The processor and operating system together define a computer platform for which application programs in high level programming languages may be written. These component applications may be executable, intermediate, for example, C−, bytecode or interpreted code which communicates over a communication network, for example, the Internet, using a communication protocol, for example, TCP/IP. Similarly, aspects in accord with the present disclosure may be implemented using an object-oriented programming language, such as .Net, SmallTalk, Java, C++, Ada, or C# (C-Sharp). Other object-oriented programming languages may also be used. Alternatively, functional, scripting, or logical programming languages may be used.

Additionally, various aspects and functions in accordance with the present disclosure may be implemented in a non-programmed environment, for example, documents created in HTML, XML or other format that, when viewed in a window of a browser program, render aspects of a graphical-user interface or perform other functions. Further, various embodiments in accord with the present disclosure may be implemented as programmed or non-programmed elements, or any combination thereof. For example, a web page may be implemented using HTML while a data object called from within the web page may be written in C++. Thus, the disclosure is not limited to a specific programming language and any suitable programming language could also be used.

Embodiments of the present disclosure, instead of measuring the weight of one or more sample, measures the width of dispensed lines of material, e.g., solder paste, as a means of providing closed loop control of the dispensed quantity. It is worth noting that measuring the line width does not produce a volume oriented measurement. As mentioned above, the line width measurement “assumes” that the dispensed line will be consistent enough in height (or, more correctly, cross-section) so that an effective means of closed loop control can be obtained from the width. Specifically, in one embodiment, a speed of the dispenser gantry may be adjusted to control the amount dispensed. In another embodiment, with an auger-type dispenser, the rotational speed of an auger of the dispensing unit may be adjusted to control the amount dispensed. In yet another embodiment, with a jetter-type dispenser, the shot size of the dispensing unit may be adjusted to control the amount dispensed.

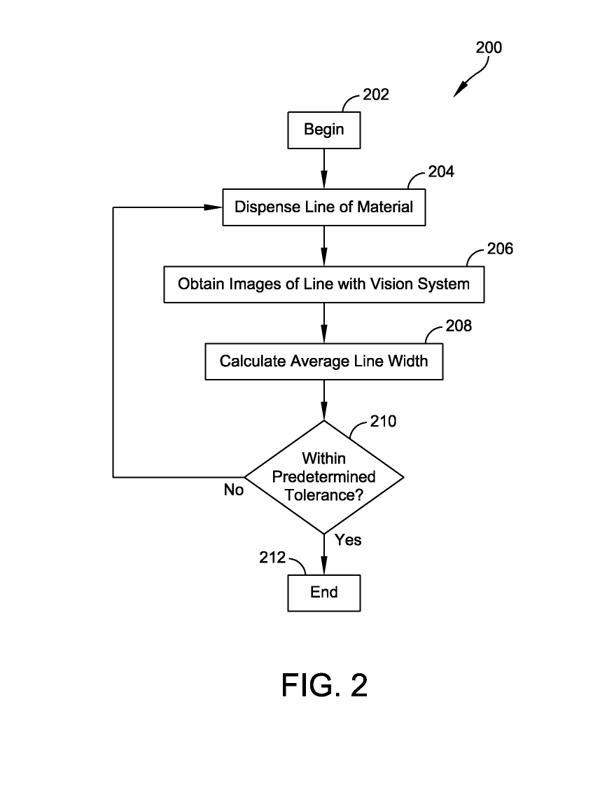

In one embodiment of the present disclosure, and with reference to FIG. 2, a method of determining an amount of material, e.g., solder paste, dispensed on a surface by performing a line width measurement routine is generally indicated at 200. As shown, the method begins at 202. At 204, the dispenser is programmed under the control of the controller to dispense a line of material, e.g., solder paste, on a surface. In a certain embodiment, the surface may be part of the weight scale. At 206, the vision system is the employed to obtain an image of the dispensed line so that one or more measurements may be made of the width of the dispensed line at one or more places along a length of the line. Specifically, the vision system captures several images along the length of the line and the controller determines a width of the line within each particular image. At 208, an average line width is calculated, and compared against a known line width. At 210, the amount of material dispensed is determined to be within a predetermined tolerance. If the amount of material is within the predetermined tolerance, e.g., within +/−ten percent (10%) of the known line width, then the method ends at 212. If the amount of material is not within the predetermined tolerance, a parameter of the dispenser is adjusted, such as the speed of the gantry, and the process is repeated at 204 until the amount of material is within the predetermined tolerance. In another embodiment, the rotational speed of the auger screw may be adjusted or the shot size of the dispenser unit may be adjusted. This process may be repeated any number of times, e.g., five.

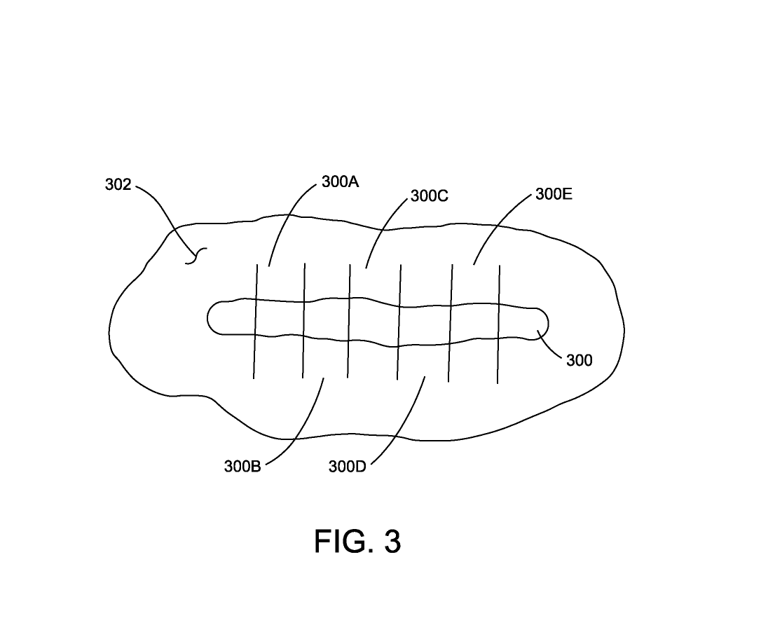

With reference to FIG. 3, a line 300 is deposited on a substrate 302. As shown, the line 300 has several line segments 300A to 300E, which are meant to represent sequential segments of the line taken by the vision system. A single image of the line 300 may be obtained, or several images may be averaged together. The segments are made by simply “cutting” the dispensed line into several segments and processing the line width of each segment independently. In one embodiment, the image captured by the vision system is 640×480 pixels. The pixel size depends on lens/spacer combinations and typically ranges from 0.1 millimeters (mm)/pixel to 0.015 mm/pixel. When using the 0.015 mm/pixel, the full frame is about 10.2 mm×7.2 mm. A typical line may be 370 pixels or 5.6 mm long. The portion of the line examined (eliminating the ends) would be 250 pixels or 3.75 mm long. For determining line width, the ends of the lines are avoided. Thus, the middle of the dispensed line 300 is measured. As shown, the vision system may be manipulated to obtain images of the dispensed line along lengths of the dispensed line in which widths of the dispensed line are measured and averaged together by the controller. The averaged width is then compared against a predetermined line width within a specified tolerance stored by the controller as described above.

With the method of determining a dispensed amount of material disclosed herein, parameters of the dispensed material, such as viscosity, are preprogrammed by the controller. Thus, when measuring line width, the height of the dispensed line is somewhat inconsequential, since the controller is preprogrammed to factor in a known height of the material based on the type of material dispensed.

The method may further include one or more of the following features:

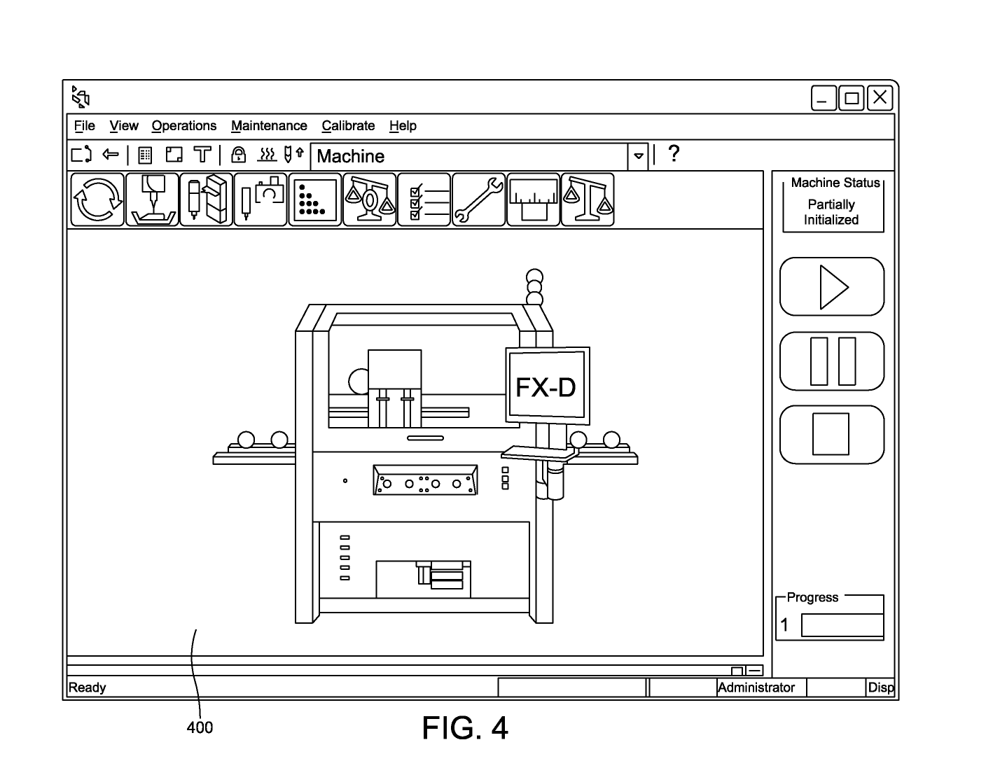

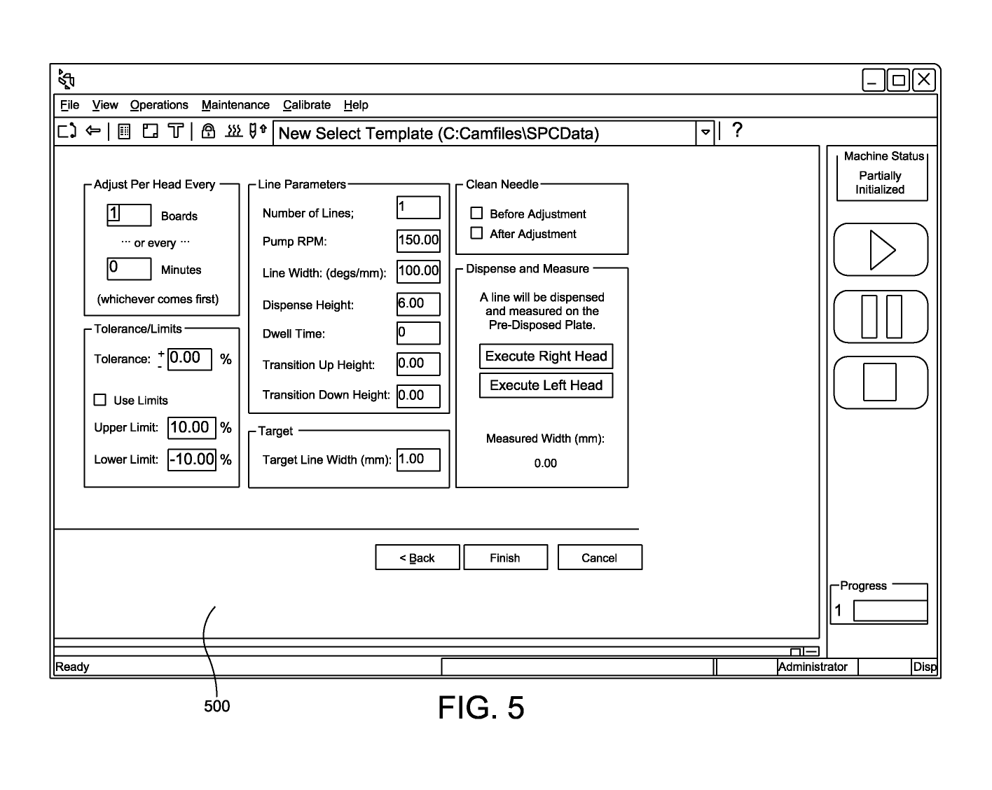

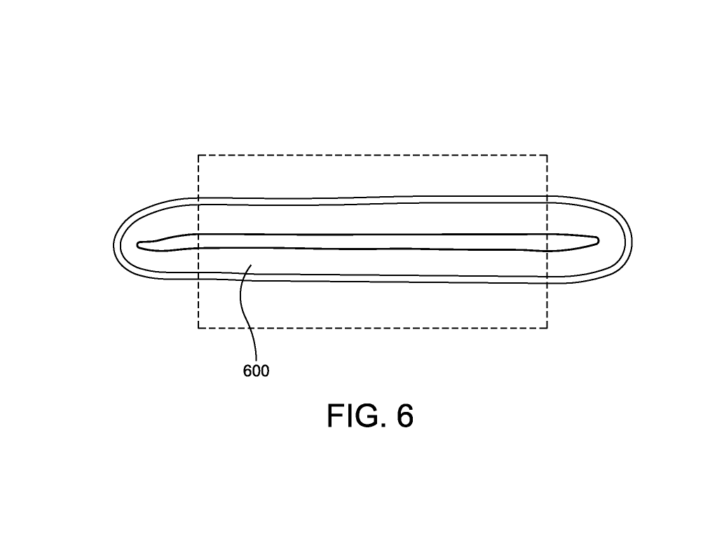

A dialog box may be provided on the display unit to set up the line width closed loop. The dialog box may be generally similar to a weigh block template. The dialog box may apply globally to all lines in the process program. In one embodiment, and with reference to FIGS. 4-6, exemplary dialog boxes are shown and described. FIG. 4 illustrates a user interface 400 that a user engages to initiate a line width measurement. FIG. 5 illustrates a user interface 500 that a user engages to perform the line width measurement process. FIG. 6 illustrates an exemplary line 600 as displayed on the display 28.

Dots of material may be adjusted by changing the rotation of the auger screw of the dispensing unit to dispense more or less material while the gantry is stationary.

The line width closed loop method may apply to dispensers having auger pumps and micro-piston pumps.

During setup, an operator may specify one or more of the following parameters: (1) RPM; (2) z-axis height; (3) rotation in degrees per mm (mm) (the “line width” column in a line command); (4) one or more pumps (left and/or right); (5) desired width (a “calculate” button may be provided and when pressed will dispense a line on a plate and calculate a line width based on the actual dispense parameters); (6) tolerance; (7) upper and lower limits; (8) measure every n boards or every n minutes; and (9) clean needle before dispensing. One or more icon on the display can be provided to assist an operator in performing an operation disclosed herein.

The length of the dispensed line and at least some of the vision parameters may not be adjustable by the user but instead may be stored in the database of the controller.

The dispensed line may be dispensed on a pre-dispense plate of the dispenser, not the substrate. In one embodiment, the pre-dispense plate may be part of the weigh station.

During execution of the method, in a certain embodiment, the dispense location on the pre-dispense plate may need to be determined in conjunction with any pre-dispense dots and/or pre-dispense line.

During execution of the method, in a certain embodiment, a z-axis sense operation will be executed before dispensing the line. (This may limit the dispense operation to only one pre-dispense plate.)

During execution of the method, in a certain embodiment, the line width will be measured as follows: (1) if the measured value is within the specified tolerance then no changes will occur; (2) if the measured value is outside the specified tolerance then the dispensing unit gantry speed will be adjusted and a new line will be dispensed on the pre-dispense plate; (3) continue with step (1) for a maximum of five times; (4) after the fifth attempt an alarm will be posted; and (5) should the result of any measurement be outside the upper or lower limits an alarm will be generated.

During execution of the method, if the pre-dispense plate is filled then the same handling currently in place for the pre-dispense dots and/or pre-dispense lines will be used.

The range of line widths are assumed to achieve a simple linear relationship with respect to adjusting the gantry speed or another alternative.

Although the embodiment of the method discussed herein performs the method under the control of the controller, an operator of the dispenser can manually initiate a width measurement operation. In a certain embodiment, results may be stored by the controller in a separate log file.

Dispensing multiple lines to increase the sample size may also be performed. Dispensing multiple lines may reduce the available number of measurement cycles before the pre-dispense plate needs cleaning. Recovery options may be provided. Accuracy tests also may be provided.

Having thus described several aspects of at least one embodiment of this disclosure, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A method of calibrating a dispenser of the type having a material dispensing unit that is configured to dispense material on a substrate, the method comprising:
dispensing a line of material on a surface;
capturing at least one image of the line dispensed on the surface;
calculating an average line width of the line dispensed on the surface; and
comparing the average line width of the line dispensed on the surface to a desired line width.

2. The method of claim 1, wherein comparing the average line width to the desired line width includes determining whether the average line width is within a predetermined tolerance.

3. The method of claim 2, wherein if the average line width is outside the predetermined tolerance, further comprising repeating dispensing, capturing, calculating and comparing until the average line width is within the predetermined tolerance.

4. The method of claim 2, further comprising adjusting a parameter of the dispenser to vary an amount of material dispensed in the event the average line width is outside the predetermined tolerance.

5. The method of claim 4, wherein adjusting the parameter of the dispenser includes adjusting a speed of the gantry.

6. The method of claim 4, wherein adjusting the parameter of the dispenser includes adjusting a rotation of an auger screw of the dispensing unit or by adjusting a shot size of the dispensing unit.

7. The method of claim 2, wherein capturing at least one image includes capturing a plurality of images at one or more places along a length of the line.

8. The method of claim 2, wherein the predetermined tolerance is ten percent (10%).

9. The method of claim 1, further comprising displaying the average line width and weight of the line dispensed to a user using a user interface device.

10. The method of claim 9, wherein the user interface device includes a display coupled to a dispenser controller.

11. A controller coupled to a dispenser of the type having a material dispensing unit that is configured to dispense material on a substrate, the controller comprising:
a calibration component configured to perform acts of
dispensing a line of material on a surface,
capturing at least one image of the line dispensed on the surface,
calculating an average line width of the line dispensed on the surface, and
comparing the average line width of the line dispensed on the surface to a desired line width.

12. The dispenser of claim 11, wherein comparing the average line width to the desired line width includes determining whether the average line width is within a predetermined tolerance.

13. The dispenser of claim 12, wherein if the average line width is outside the predetermined tolerance, further comprising repeating dispensing, capturing, calculating and comparing until the average line width is within the predetermined tolerance.

14. The dispenser of claim 12, further comprising adjusting a parameter of the dispenser to vary an amount of material dispensed in the event the average line width is outside the predetermined tolerance.

15. The dispenser of claim 14, wherein adjusting the parameter of the dispenser includes adjusting a speed of the gantry.

16. The dispenser of claim 14, wherein adjusting the parameter of the dispenser includes adjusting a rotation of an auger screw of the dispensing unit or by adjusting a shot size of the dispensing unit.

17. The dispenser of claim 12, wherein capturing at least one image includes capturing a plurality of images at one or more places along a length of the line.

18. The dispenser of claim 12, wherein the predetermined tolerance is ten percent (10%).

19. The dispenser of claim 11, further comprising displaying the average line width and weight of the line dispensed to a user using a user interface device.

20. The dispenser of claim 19, wherein the user interface device includes a display coupled to a dispenser controller.
